(19) United States
(12) Patent Application Publication
(10) Pub. No.: US 2024/0057560 A1
(43) Pub. Date: Feb. 22, 2024

(54) ANIMAL COLLAR AND METHOD

(71) Applicant: Brett Kuhnsman, Reno, NV (US)

(72) Inventor: Brett Kuhnsman, Reno, NV (US)

(21) Appl. No.: 18/236,393

(22) Filed: Aug. 21, 2023

Related U.S. Application Data
(60) Provisional application No. 63/399,707, filed on Aug. 21, 2022.

(51) Int. Cl. A01K 27/00

(52) U.S. Cl. CPC A01K 27/001

(57) ABSTRACT

A pet collar sleeve and pet collar combination and method, the combination comprising a double open-ended pet collar sleeve made from an animal fur pelt, a fur portion of animal fur pelt forms an outside surface of a double open-ended sleeve, the double open-ended sleeve further forms a hollow interior that continuously connects two open ends of the double open-ended sleeve; and a pet collar comprising a double-ended strap; wherein a portion of the pet collar is held within the hollow interior to present the fur portion of the animal fur pelt to a fur-bearing pet.

### CROSS-REFERENCE TO OTHER APPLICATIONS

This application claims the benefit of U.S. Provisional Patent Application No. 63/399,707 filed on Aug. 21, 2022, and entitled “ANIMAL COLLAR AND METHOD”, the entire contents of which are incorporated by reference.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to animal collars as generally worn by non-human animals. More particularly to those animal collars that may present a portion of a fur to fur-bearing, non-human animals.

### BACKGROUND

An animal collar may comprise double-ended length of material (e.g., a strap) that may be applied to a neck of non-human animal such as a cat, dog or the like that may be further considered pets. The ends of the collar strap may be permanently connected together in a loop or may be removably connected together in a manner (e.g., via a releasable closure or locking device like a buckle, clasp or the like) or may be permanently connect the two ends together, In either version that may allow the strap or length of double ended material to form a collar loop that may generally encircle a portion (e.g., neck) of the non-human animal. The animal collar locking connection version may allow a circumference of the collar loop to be adjusted to accommodate a selected portion of the non-human animal (e.g., neck) in a generally comfortable manner and yet be able to generally resist the non-human animal from pulling off the said animal collar.

One possible issue with pet collars may be that non-human animals to which per collars may be applied may dislike or resist the application of such pet collars. Sometimes this reaction to the pet collar may be due to the non-human animal appearing to have a nervous, irritable or antisocial disposition. As such, these animals may exhibit discomfort on the application of such animal collars.

### SUMMARY OF ONE EMBODIMENT OF THE INVENTION

One possible solution to this problem may be the present invention which may be an animal collar which may further comprise a portion of animal fur that may be presented to substantiality contact the skin, fur or both of a non-human, fur bearing animal wearing the invention. This application of the invention has been observed to induce a calming effect on otherwise nervous, irritated or anti-social non-human, fur-bearing animals.

### Advantages of One or More Embodiments of the Present Invention

The various embodiments of the present invention may, but do not necessarily, achieve one or more of the following advantages:
to provide a means of presenting animal fur or faux animal fur to a generally non-human mammal or fur-bearing animal pets to substantially induce a calming effect upon the said generally non-human mammal or fur bearing animal pet;
the ability to calm an agitated fur-bearing animal or mammal pet that may otherwise has a nervous disposition by contacting said pet with fur that is generally not originating from the said animal pet;
to provide a pet collar generally encapsulated with a double-opened sleeve made from animal fur, the said fur being presented on the outside of the pet collar and generally projecting outward from said pet collar;
the ability to removably enhance a pet collar with a calming capability so that when the pet collar is applied to a mammalian animal pet with first state of agitated, excited or antisocial behavior, the invention's contact with the mammalian animal pet then may help move the said pet to a second and calmer state of behavior;
provide a pet collar that is having an animal fur sleeve, the animal fur sleeve being removable for cleaning and servicing;
the ability to generally promote removable contact of a first animal fur of first fur-bearing animal with a second animal fur of a second fur bearing animal with that may promotes a calming effect upon the second fur-bearing animal, and
provide a collar that may mimic an interaction between a fur-bearing non-human animal and the said fur bearing animal's mother to cause a remembrance or condition within the fur-bearing non-human animal that induces a calming effect upon the said fur-bearing non-human animal.

These and other advantages may be realized by reference to the remaining portions of the specification, claims, and abstract.

### Brief Description of One Embodiment of the Present Invention

One possible embodiment of the invention could be a pet collar sleeve comprising a double open-ended sleeve made from a portion of a tanned pelt, the fur portion of the animal fur forms an outside of the double open-ended sleeve, the double open-ended sleeve further forms a hollow interior configured to removable receive and partially encapsule a pet collar; wherein contact of the pet collar sleeve combination with the skin, fur or both of a non-human animal has a calming effect upon the said non-human animal.

Another possible embodiment of the invention could be a pet collar sleeve and pet collar combination comprising: a double open-ended pet collar sleeve made from an animal fur pelt, a fur portion of animal fur pelt forms an outside surface of a double open-ended sleeve, the double open-ended sleeve further forms a hollow interior that continuously connects two open ends of the double open-ended sleeve; a pet collar comprising a double-ended strap; wherein a portion of the pet collar is held within the hollow interior to present the fur portion of the animal pelt to a fur-bearing pet.

Yet another possible embodiment of the invention could a process or method of operating a fur pet collar upon a fur-bearing pet comprising the following steps: providing the fur pet collar that presents a fur portion of an animal fur pelt extending outward from an outside surface of the fur pet collar; providing a fur-bearing pet; removably applying the fur pet collar to a respective fur-bearing pet; and contacting the fur portion of the animal fur pelt with a portion of the fur-bearing pet.

Still yet another possible combination of a fur pet collar and fur-bearing pet comprising the fur pet collar that presents a fur portion of an animal fur pelt extending outward from an outside surface of the fur pet collar; the fur-bearing pet; wherein the fur pet collar is located upon the fur bearing pet so that a fur portion of the animal fur pelt contacts a portion of the fur-bearing pet.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and conducted in multiple ways. Also, it is to be understood that the phraseology and terminology employed herein are for the purpose of description and should not be regarded as limiting.

### BRIEF DESCRIPTION OF THE DRAWINGS

FIG. 1 is substantially a cutaway perspective view of one embodiment of the present invention.

FIG. 2 is substantially a perspective view of one embodiment of the present invention with a structural collar and fur sleeve separated from one another.

FIG. 3 is substantially a perspective view of another embodiment of the present invention.

FIG. 4 is substantially a perspective view of one embodiment of the present invention as applied to a fur-bearing, non-human animal.

FIG. 5 is substantially flowchart schematic for showing a process or method for operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

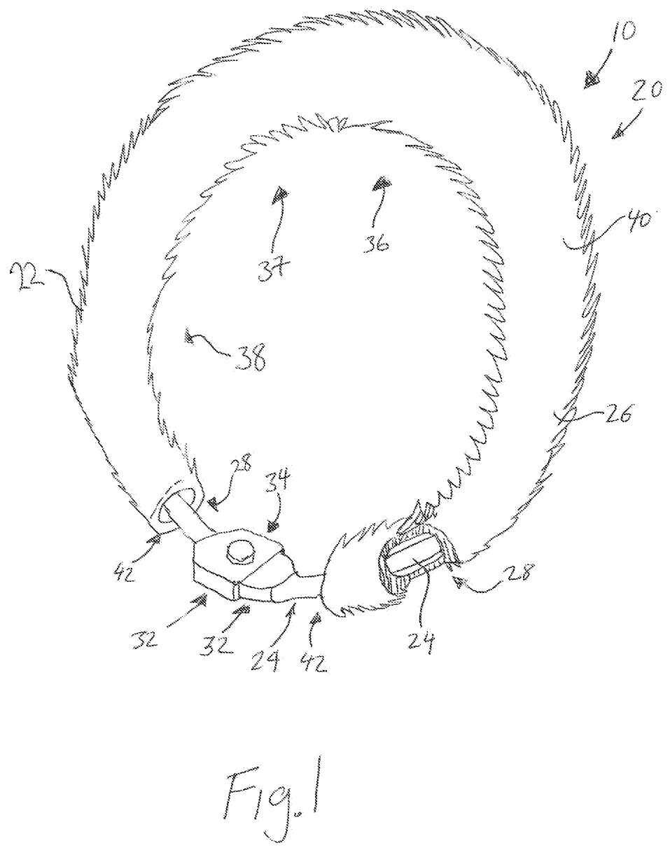

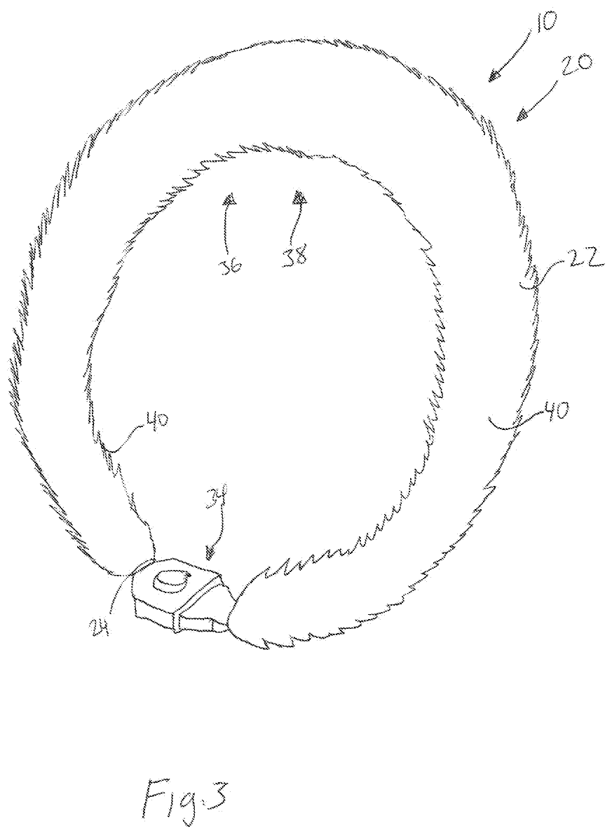

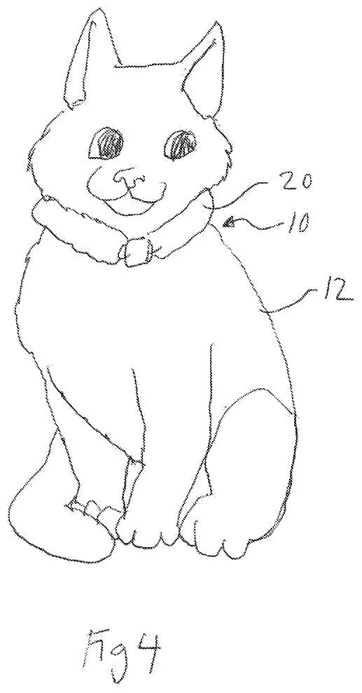

As shown in FIG. 1, the present invention 10 could comprise an pet collar 20 that presents a fur-bearing exterior animal collar surface 22 to a respective (generally a non-human animal) fur-bearing (e.g., mammal) animal pet like a cat, dog, rabbit or the like 12 (e.g., as substantially shown in FIG. 4) wearing the said pet collar 20 and method or process for same 100. As shown in FIGS. 1-3, one possible embodiment of the pet collar 20, could comprise a structural collar 24 and a fur sleeve 26 that may be configured to removably encompass at least a portion of the structural collar 24 within the fur sleeve's hollow interior 28. The structural collar 24 in one possible version could comprise a strap 30 (e.g., a double-ended, definite length of material.) The strap 30 could comprise flexible or pliable material or materials (e.g., material such as a chain, cable cord, or the like). The strap 30 could terminate in respective collar ends 32 that may be removably connected together by a locking device 34, such as a buckle, clasp, snap or the like to generally removably form a collar loop 38 that may be adjustable to change the collar loop's circumference 36. In other embodiments, the strap 30 could be made from an elastic, continuous circular band of material (not shown) that could suitably expand and contract the collar loop's circumference 36 to comfortably pass over the said animal's head 14 (e.g., as substantially shown in FIG. 4) and then adjust to rest comfortably rest upon the animal's neck 16 (e.g., as substantially shown in FIG. 4) and still resist the animal's attempt to slip out of the animal pet collar 20.

The corresponding fur sleeve 26 could comprise a generally rectangularly-shaped portion of a pelt 40 (e.g., generally a tanned or cured skin of an animal with the fur [e.g., fur may be seen as growing to a certain length] or hair [e.g., like wool, which may continuously grow and requires repeated cutting to maintain certain length], or both generally presented on one side of tanned or cured skin as such). Pelts 40 could be those from mink, beaver, coyote, rabbit, or other such animals whose fur may be used to make coats, jackets or stoles. In another possible version, the pelt 40 could be synthetic or lab created/bio-printed (e.g., a laboratory grown cell-based fur, hair or both.) In either version, the pet collar 20 could present on pet collar's exterior surface 22 a fur (a pelt 40) that extends outward from the pet collar 20 to contact the mammalian animal pet 12.

Longitudinal edges of the generally rectangularly shaped pelt 40 could be connected (e.g., sewn together) to substantially form a double open-ended fur sleeve 26 further configuring a hollow sleeve interior 28 that may continuously connect two open sleeve ends 42. The hollow sleeve interior 28 could be configured to further removably receive at least a portion of corresponding open-ended structural collar 24. In another embodiment rectangularly shaped pelt could be sewn to form the double open-ended fur sleeve 26 about a portion of a continuous loop structural collar 24.

One version of the invention 10 could further comprise a set (not shown) of double open-ended fur sleeves 26 constructed from pelts 40 of different animals (e.g., each fur sleeve 26 being made from a pelt 40 of a different animal). The operator (not shown) then could select one fur sleeve 26 from the set of fur sleeves 26 to begin to assemble the invention 10 for application to animal. The structural collar 24 could be unbuckled, unclasped or the like to release the structural collar from its continuous loop configuration back into its open-ended strap 30. One collar end 32 could be inserted into one open sleeve end 42 to generally present the structural collar 24 into the sleeve's hollow interior 28. The structural collar 24 is generally passed into the sleeve hollow interior 28 until each collar end 32 protrudes out from a respective open sleeve end. The invention may then be placed around a portion of the animal (e.g., around the neck 16 or like, as substantially shown in FIG. 4) so that the two ends of the pet collar 20 are brought within proximity of each other to allow the locking mechanism 34 to engage the collar ends 32 and generally form the collar loop 38 allowing the invention 10 to removably engage the selected pet with the hair, fur or alike of the animal collar 20 coming into contact with the selected pet 12. Other means of attaching an animal pelt 40 to the structural collar 24 could also be considered within the scope of the invention 10 (e.g., using hook and loop to removably hold the pelt 40 to the structural collar 24.)

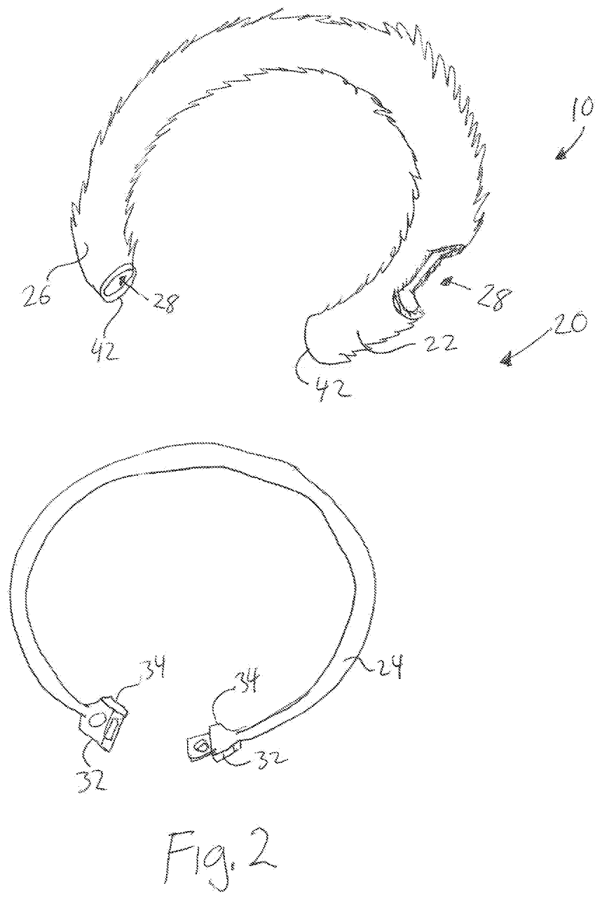

Another embodiment of the invention 10, as substantially shown in FIG. 2 could be wherein a portion of the pelt 40 may be directly and permanently attached to the structural collar 42. In this manner, the pelt 40 could be glued, sewn or otherwise permanently attached to the structural collar 24 so as to project the hair, fur or alike generally outward from the assembled pet collar 20. The pet collar 20 could present on its exterior surface 22 a fur (a pelt 40) that extends outward from the pet collar 20 to contact the pet 12.

There have been observations over several occasions with several different fur-bearing pets that the applied invention 10 substantially imparted a calming effect to the collared pet 12. It is generally thought that the invention 10, when applied to the selected fur-bearing pet 12, it thought that the applied invention 10 when applied to the animal 12, may remind the animal of when the pet 12 was young and with its mother (not shown). In such circumstances, the mother when holding the pet 12 (when young) may hold the animal in close contact with the pet's mother's fur (not shown). These close contact associations and memories of same could possibly be an explanation for the invention 10 imparting calming effect to a pet 12 wearing the invention. Prior to wearing the invention 10, the fur-bearing animal or pet 12 (e.g., dog, cat or other) may have been observed to be shy, skittish, fearful or unwilling to interact (e.g., runs away and hides), agitated, highly excited or highly excitable first state of behavior in relation to the animal's owner, other people or other animals. Once the invention 10 is substantially applied to the said pet 10 that has been generally previously noticed to having negative attitudes, those negative attitudes appear to be abated the animal exhibits a second or calmer state of behavior. The pet 12 combined with the invention 10, may now interact more easily or gentler with the animal owner and others (not shown) on a much greater and friendlier basis (to substantially being seen as an entirely different animal, personality-wise.) Once the invention 10 is generally removed from the pet 12, the pet 12 may appear to quickly revert back to animal's earlier first state of behavior and personality.

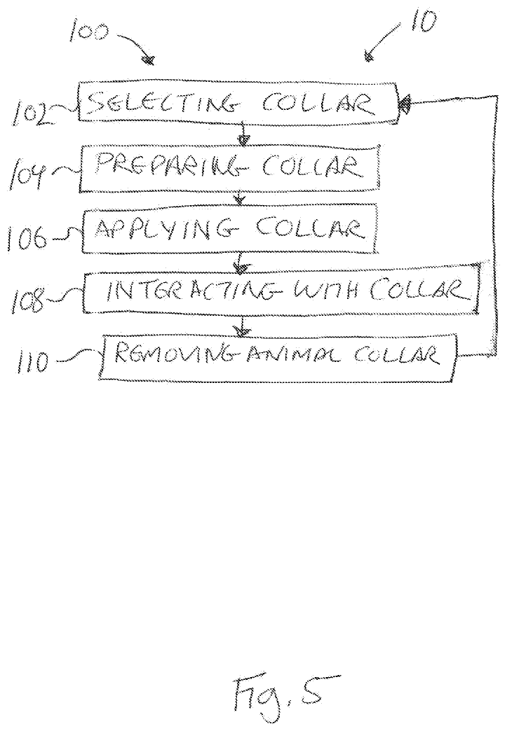

As substantially shown in FIG. 5, the method or process 100 for operating the invention could start with step 102, selecting the animal collar. In this step, an operator could obtain the invention, which may in one version may be an adjustable collar with one or more removable fur-presenting interchangeable collar sleeves. The animal collar may be selected based on the type and size of fur-bearing animal to which the animal collar is to be applied. Once the animal collar is substantially selected, the combination of collar and interchangeable fur bearing sleeve(s) may be obtained for application to the desired fur-bearing animal.

In another embodiment, the invention may be a single animal collar having an outside or exterior surface permanently presenting a certain type of animal fur. The animal collar may further be selected based on the type and size of fur-bearing animal to which the animal collar may be applied. Other design and utility criteria may be employed as well for final animal collar selection.

Once this step is substantially completed, the process 100 could proceed to step 104, preparing the animal collar.

At step 104, preparing the animal collar, the operator may decide on which fur sleeve to apply to the structural collar or which animal collar to be applied. This selection maybe be done on design or fashion criteria (e.g., color, fur length, design), utility criteria (type of animal collar fur, the type of animal to which the animal collar is being applied, expected interaction of the assembled animal collar fur to animal's fur that is expected, etc.) or both.

Once the selection is done, the animal collar which in one embodiment, ah comprise of structural collar and a fur sleeve, the structural collar having two collar ends generally being removably connected together through a locking device, may be unlocked as needed to substantially allow the two collar ends to separate from one another. This unlocking action could allow the operator to drop one collar end into the fur sleeve's one hollow interior open end. The structural collar could then pass through into the fur sleeve's hollow interior until both collar ends extend out from the fur sleeve's hollow interior. The invention may be ready to be applied to the selected or desired animal.

In another version of the animal collar, wherein the fur (e.g., pelt) may be affixed to or is directly a part of the collar structure. The structural collar may be double ended with the two collar ends generally being removably connected together through a locking device. The locking device may be unlocked to substantially allow the two ends to separate from one another. The invention, in these versions with the open collar, may then be ready to be applied to the selected or desired animal.

Wherein for the embodiment where the animal collar could substantially comprise a fur bearing permanently continuously connected elastic collar, the operator could manually stretch the animal collar to increase the animal collar's circumference to allow the animal collar to be slipped over a portion of the animal (e.g., the animal's head.)

Once this step is substantially completed, the process 100 could proceed to step 106, applying the animal collar.

In step 106, applying the animal collar, the operator could procure and hold the desired animal steady so the animal will not move off from the operator. The operator may bring the animal collar to the animal to which the invention is to be applied. In one embodiment of the invention, the operator could then bring the otherwise open collar ends collar ends together around the neck of the said animal to engage the locking device. By engaging the locking device, the operator could further adjust the overall circumference of the animal collar wherein the animal collar is worn conformably upon the animal but will not allow the animal to slip the collar past the animal's head.

In another embodiment, the overall circumference of the animal collar may be first adjusted accordingly though the use of the locking device to allow the animal collar to fit over the head of the selected animal and to come to rest around the animal's neck. In this manner, when the animal pulls back from the animal collar (e.g., when the animal collar attached to a held lease), the back of the animal's jaw may hold onto the animal collar, substantially preventing the animal from slipping out of the animal collar.

In yet another embodiment, wherein the animal collar substantially comprising an elastic continuous band forming a loop and a respective adjustable circumference, the animal collar could be held open to slip over the animal's head. Once over the animal's neck, the animal collar could be released to allow the elastic continuous band to contract to a smaller circumference that is more fitting to the animal's neck. In this manner, when the animal pulls back from the animal collar (e.g., when the animal collar attached to a held lease), the back of the animal's jaw may hold onto the animal collar, substantially preventing the animal from slipping out of the animal collar.

Once this step is substantially completed, the process 100 could proceed to step 108, interacting with the animal collar.

In step 108, interacting with the animal collar, the applied invention's fur portion (e.g., pelt) may contact the fur/hair/skin of the animal wearing the invention. This contact could cause a change in the behavior of the animal wearing the invention. The combination of animal and invention could result in an imparting of a substantially noticeable claiming effect upon the animal. If the animal prior to wearing the invention is reticent (e.g., be shy, skittish, fearful or unwilling to interact [e.g., runs away and hides] in relation to the animal's owner, other people or other animals) then possibly upon wearing the invention, the animal becomes more relaxed friendly to people and other animals. The animal may approach people and interact with people (e.g., allows the people to pet, hold or both the animal.) If the animal seems to be high strung or nervous (e.g., running away, hiding under furniture, and the like) then upon wearing the animal collar, the animal may become more friendly and playful rather than being skittish and running away from people. Once this step is substantially completed, the process 100 could proceed to step 110, removing the animal collar.

At Step 110, removing the animal collar, in one embodiment of the invention, the operator could deactivate the locking device, allowing the disengagement of the collar ends from one another and permit the animal collar to be pulled off the animal's neck. In another embodiment of the invention (e.g., an elastic band loop-type animal collar version) providing a collar loop with an adjustable conference, the animal collar could be stretched or otherwise manipulated to allow the animal collar to be pulled over the animal's head and be removed from contact with the animal.

At the substantial competition of this step, the process 100 could return to step 106, selecting the collar as needed.

### CONCLUSION

Although the description above contains many specifications, these specifications should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A pet collar sleeve and pet collar combination comprising:
(A) a double open-ended pet collar sleeve made from an animal fur pelt, a fur portion of animal fur pelt forms an outside surface of a double open-ended sleeve, the double open-ended sleeve further forms a hollow interior that continuously connects two open ends of the double open-ended sleeve;
(B) a pet collar comprising a double-ended strap;
wherein a portion of the pet collar is held within the hollow interior to present the fur portion of the animal pelt to a fur-bearing pet.

2. The combination of claim 1 wherein the doubled-ended strap further comprises a lock to removably connect the strap ends in a manner that the pet collar forms a loop.

3. The combination of claim 2 wherein a lock allows the loop to be adjustable in size to fit the fur-bearing pet.

4. The combination of claim 1 wherein the animal fur pelt is selected from one of a group of animal pelts consisting of mink pelt, beaver pelt, coyote pelt, rabbit pelt.

5. The combination of claim 1 wherein the animal fur pelt is synthetic.

6. A method of operating a fur pet collar upon a fur-bearing pet comprising the following steps shown:
(A) providing the fur pet collar that presents a fur portion of an animal fur pelt extending outward from an outside surface of the fur pet collar;
(B) providing a fur-bearing pet;
(C) removably applying the fur pet collar to a respective fur-bearing pet; and
(D) contacting the fur portion of the animal fur pelt with a portion of the fur-bearing pet.

7. The method of claim 6 wherein the providing a fur-bearing pet further has the fur-bearing pet in a first state of behavior wherein the fur-bearing pet is agitated or excited.

8. The method of claim 7 wherein the contacting the fur portion of the animal fur pelt to the portion of the fur-bearing pet moves the fur-bearing pet from a first state of behavior to a second state of behavior that is calmer and less agitated than the first state of behavior.

9. The method of claim 6 wherein the portion of the fur-bearing pet is a portion of fur-bearing pet's skin.

10. The method of claim 9 wherein the portion of fur-bearing pet's skin further presents a portion of fur of the fur-bearing pet.

11. The method of claim 6 further comprising a step of adjusting the fur pet collar to fit a respective fur-bearing pet and a step of aligning the fur portion of the animal fur pelt to contact the fur-bearing pet.

12. The method of claim 6 wherein the providing a fur pet collar further provides a double open-ended sleeve made from the animal fur pelt, the double open-ended sleeve further forms a hollow interior that continuously connects two open ends of the double open-ended sleeve; and further providing a double-ended collar strap, wherein a portion of the double-ended collar strap is removably held within the hollow interior in manner to present the fur portion of the animal fur pelt to the fur-bearing pet.

13. The method of claim 12 wherein the double-ended collar strap further comprises a lock to removably connect the collar strap ends in a manner that the fur pet collar forms a loop.

14. The method of claim 13 further comprising a step of operating the lock to adjust the size of the loop to respectively fit the fur-bearing pet.

15. A combination of a fur pet collar and fur-bearing pet comprising:
(A) the fur pet collar that presents a fur portion of an animal fur pelt extending outward from an outside surface of the fur pet collar;
(B) the fur-bearing pet;
wherein the fur pet collar is located upon the fur bearing pet so that a fur portion of the animal fur pelt contacts a portion of the fur-bearing pet.

16. The combination of claim 16 wherein the animal fur pelt is synthetic.

17. The combination of claim 16 wherein the animal fur pelt is one selected from a group of animal pelts consisting of mink pelt, beaver pelt, coyote pelt, rabbit pelt.

18. The combination of claim 16 wherein the portion of the fur-bearing pet is a portion of fur-bearing pet's skin, fur or both.

19. The combination of claim 16 wherein the fur pet collar further comprises a double open-ended sleeve made from the animal fur pelt, the double open-ended sleeve further forms a hollow interior that continuously connects two open ends of the double open-ended sleeve; and further providing a double-ended strap, wherein a portion of the double-ended strap is removably held within the hollow interior in manner so that the fur portion of the animal fur pelt contacts a portion of the fur-bearing pet.
